(19) United States
(12) Patent Application Publication
(10) Pub. No.: US 2026/0117896 A1
(43) Pub. Date: Apr. 30, 2026

(54) Flexible pipe and a method of manufacturing a flexible pipe

(71) Applicant: Polyflow LLC, Midland, TX (US)

(72) Inventors: Malcolm Werner Kurt ROSENOW, Aiken, SC (US); Matthew Leonard RYAN, The Woodlands, TX (US); Wayne Peter Robert CALDWELL-BARR, The Woodlands, TX (US); Jean-Louis POISSON, Cypress, TX (US)

(73) Assignee: Polyflow LLC, Midland, TX (US)

(21) Appl. No.: 18/929,509

(22) Filed: Oct. 28, 2024

(51) Int. Cl. F16L 11/08; B29C 48/00; B29C 48/10; B29C 48/21; B29L 23/00; B32B 1/08; B32B 27/08; B32B 27/18; F16L 11/04

(52) U.S. Cl. CPC F16L 11/081; B32B 1/08; B32B 27/08; B32B 27/18; B29C 48/0021; B29C 48/10; B29C 48/21; B29L 2023/005; B32B 2250/24; B32B 2262/103; B32B 2262/16; B32B 2264/108; B32B 2264/20; B32B 2307/308; B32B 2307/546; B32B 2597/00; F16L 2011/047

(57) ABSTRACT

A flexible pipe for conveying oil and gas field fluids, the pipe comprising a pipe body comprising first and second pipe layers. The first pipe layer is an innermost pipe layer, and the second pipe layer is an outermost pipe layer. At least one of the first and second pipe layers is a composite layer formed of a reinforcement embedded in a thermoplastic matrix material. A heat distortion temperature of the composite layer is greater than 200° F. as tested in accordance with ASTM D648 or ISO 75 using an outer fibre stress of 0.455 MPa. There is also provided a method of manufacturing a flexible pipe.

### TECHNICAL FIELD

The invention relates to a flexible pipe, particularly to a flexible pipe for conveying oil and gas field fluids. The invention further relates to a method of manufacturing a flexible pipe.

### BACKGROUND

Flexible composite pipe has been replacing steel in many applications with great success, including oil and gas pipelines, due to its versatility and durability. Flexible composite pipe is used in conveying oil and gas field fluids, such as water, gas (for example methane, ethane, CO₂), and hydrocarbon fluids, or other fluids such as hydrogen, and is typically used onshore or in shallow water applications (for example, less than 500 m water depth).

Reinforced thermoplastic pipe (RTP) is an example of a multi-layer flexible composite pipe reinforced by high-strength materials. RTP is suited to gas and oil transportation because of its flexibility and high strength, being capable of internal pressures exceeding 5,000 psi (˜34.5 MPa), and may be qualified and supplied in accordance with the American Petroleum Institute specification API 15S. RTP is corrosion-resistant and more durable than steel pipe: RTP can withstand salt corrosion, as well as H₂S/CO₂ corrosion, hence contributing to a longer lifespan when compared to steel pipe. Moreover, RTP can provide high flowrates due to a smooth inner surface and the inherent flexibility of the pipe, which removes the need for elbows. Furthermore, RTP is extremely efficient to install, being manufactured, delivered, and installed in long lengths supplied on reels, as opposed to metallic lined pipe which is supplied in short straight lengths. When considering the full-service life of RTP, RTP thereby has a lower financial and environment cost than metallic lined pipe. However, the performance of polymer layers of RTP may degrade over time, particularly at higher temperatures, and may thereby restrict the applications of RTP.

RTP typically comprises at least one reinforcement layer to withstand internal pressure and/or tension in the pipe when in use. Such reinforcement layer may comprise tapes, long fibres, fibre strands, braids and the like, the filaments of which may be from one or more of steel, glass, carbon, aramid, basalt, or polyester, and which may also comprise a matrix material of a thermoplastic polymer. Fibres and/or strands or braids of fibres may be wound around the pipe in a helical manner, with lay angles optimised for pipe performance (the higher the angle the greater the pressure retainment capability, the lower the angle the greater the tension capability), or interwoven into a braid around the liner pipe. Multiple layers of reinforcement may be applied sequentially at different lay angles to optimise and provide torsional balance to the structure in manufacture and use, i.e., RTP may comprise one or more intermediate reinforcement layers. The at least one reinforcement layer must resist creep of underlying polymer layers to prevent the underlying polymer layers from pushing between and past the tapes, long fibres, fibre strands, braids and the like of the reinforcement layer and, in turn, inducing failure of RTP.

RTP may further comprise an inner liner of polymer, and an outer protective polymeric sheath layer. The inner liner layer may comprise a single layer and material, or a plurality of sub-layers co-extruded or co-axially extruded over each other with optional tie layers to ensure retaining between incompatible polymer layers. Polymers for RTP manufacture include MDPE, HDPE, XLPE, PE-RT, polyamides (for example, PA-12, PA-11, PA-66, PA-6), thermoplastic elastomers, flexible polyvinyl chloride, acrylonitrile butadiene styrene (ABS), polyphenylene sulphide (PPS), though other polymers or polymer alloys may be used.

RTP may be either of an unbonded construction, where the layers of the pipe are unbonded to each other, i.e., the inner fluid containing polymer liner layer is not bonded to the reinforcement layer, which is in turn not bonded to the outer protective sheath polymer layer, or of a bonded construction, i.e., all layers are bonded to each other as part of the pipe manufacturing resulting in a pipe which is in effect a single, consolidated layer comprising sub-layers. Unbonded RTP may be suitable for similar applications to bonded RTP, but is manufactured differently. In comparison with bonded RTP, unbonded RTP may be manufactured more quickly (as there is no need to bond or consolidate layers along the full length of the pipe, nor additional inspection to confirm such retaining is achieved), and is therefore more cost effective, and results in a pipe which is more flexible during handling and installation, being able to maintain and operate at a smaller bend radius without risk of damage to the pipe structure.

An end fitting, or coupling, provides a sealing transition between the pipe and a connecting component, and transmits normal service loads acting on the pipe without allowing the pipe to fail. End fittings may be used for connecting sections of RTP to one another or for connecting a section of RTP to, for example, terminal equipment. As such, RTP can be used, inter alia, to provide a flexible composite pipe assembly for transporting fluids from a well-head location to an export terminus, or to a refinery. In such a pipe assembly, a first section of RTP may be connected to one or more further sections of RTP. Each section of RTP may include at least one end fitting.

RTP may be spooled, or fed, on to a reel for storage. Spooling of RTP may take place as part of the manufacture of RTP, such that RTP may be spooled at an elevated temperature. Spooling RTP at the elevated temperature and/or storing RTP on the reel for extended periods of time may result in permanent ovality of RTP. The ovality of RTP may induce premature failure of RTP and/or impair the integrity or ease of the connection between RTP and an end fitting. The ovality of RTP may also promote disorganisation of the filaments of the at least one reinforcement layer through creep, leading to the underlying polymer layers pushing between and past the tapes, long fibres, fibre strands, braids and the like of the at least one reinforcement layer.

It is an object of embodiments of the invention to reduce ovality of the inner liner layer of the flexible pipe, in particular for RTP, and/or at least mitigate one or more problems associated with known arrangements.

### SUMMARY OF THE INVENTION

According an aspect of the invention, there is provided a flexible pipe for conveying oil and gas field fluids, the pipe comprising a pipe body comprising first and second pipe layers, the first pipe layer being an innermost pipe layer and the second pipe layer being an outermost pipe layer, wherein at least one of the first and second pipe layers is a composite layer formed of a reinforcement embedded in a thermoplastic matrix material, and wherein a heat distortion temperature of the composite layer is greater than 200° F. as tested in accordance with ASTM D648 or ISO 75 using an outer fibre stress of 0.455 MPa. This arrangement may improve the creep resistance, and/or stiffness, of at least one of the first and second pipe layers of the flexible pipe, thereby reducing ovality of at least one of the first and second pipe layers, during and/or following spooling of the flexible pipe for storage. Reducing ovality of at least one of the first and second pipe layers, in turn, reduces the risk of premature failure of the flexible pipe, improves the connection between the flexible pipe and an end fitting, and/or reduces the rate of age-related creep failure. The reinforcement may additionally, or alternatively, increase the resistance of the pipe, or of induvial pipe layers, to collapse.

In certain embodiments, the reinforcement may comprise at least one of a plurality of fibres, a plurality of polygonal particles, and a two-dimensional material. The plurality of fibres may comprise short fibres. The two-dimensional material may comprise graphene.

In certain embodiments, the plurality of fibres may comprise one of aramid fibres, glass fibres, basalt fibres, and carbon fibres.

In certain embodiments, the thermoplastic matrix material may comprise one of a polyvinylidene fluoride, a polyethylene, a polyphenylene sulphide, a polypropylene, a thermoplastic elastomer, and a polyamide.

In certain embodiments, the first pipe layer may provide an inner liner and/or the second pipe layer may provide an outer cover.

In certain embodiments, the pipe body may comprise a third pipe layer disposed intermediate the first and second pipe layers. The pipe body may comprise layers consisting of only the first, second and third pipe layers.

In certain embodiments, the third pipe layer may comprise one of a pressure armour reinforcement layer, a diffusion barrier, and an insulation layer. The improved creep resistance of the first pipe layer and/or the second pipe layer may prevent the thermoplastic matrix material thereof from pushing between and past a further reinforcement of the reinforcement layer.

In certain embodiments, the third pipe layer may comprise one or more helically wrapped tapes comprising a plurality of metallic wires embedded in a thermoplastic matrix material.

In certain embodiments, the third pipe layer may comprise one or more helically wrapped tapes comprising a plurality of non-metallic unidirectional long fibre tows embedded in a thermoplastic matrix material.

In certain embodiments, a plurality of the helically wrapped tapes may form at least two distinct sub-layers within the third pipe layer, the sub-layers being wound with opposing helical orientations.

In certain embodiments, the helically wrapped tapes of each sub-layer may be applied with at least a partial overlap.

According to a further embodiment of the invention, there is provided a method of manufacturing a flexible pipe for conveying oil and gas field fluids, the method comprising: forming a flexible pipe, the pipe as described above, wherein the forming includes extruding the composite layer such that the thermoplastic matrix material is at an elevated temperature relative to ambient temperature; and feeding the flexible pipe onto a reel before the thermoplastic matrix material has cooled to ambient temperature. Reinforced thermoplastics when extruded have less creep under load at elevated temperatures compared to unreinforced thermoplastics, so when extruding the pipe onto the reel, even when still warm from the extrusion process, the pipe may experience less ovality of at least one of the first and second pipe layers.

### BRIEF DESCRIPTION OF THE DRAWINGS

FIG. 1 is a cross-sectional view of a flexible pipe according to an embodiment of the invention; and

FIG. 2 is a cross-sectional view of a flexible pipe according to a further embodiment of the invention.

### DETAILED DESCRIPTION OF EMBODIMENTS OF THE INVENTION

Embodiments of the invention may have particular application for use as an onshore pipe for conveying oil and gas field fluids, such fluids including one or more of gas (e.g., methane, ethane, hydrogen, or CO₂), hydrocarbon fluids (e.g., oil), water, or other fluids (e.g., slurry). Moreover, embodiments of the invention may have particular application as RTP. However, other applications are contemplated.

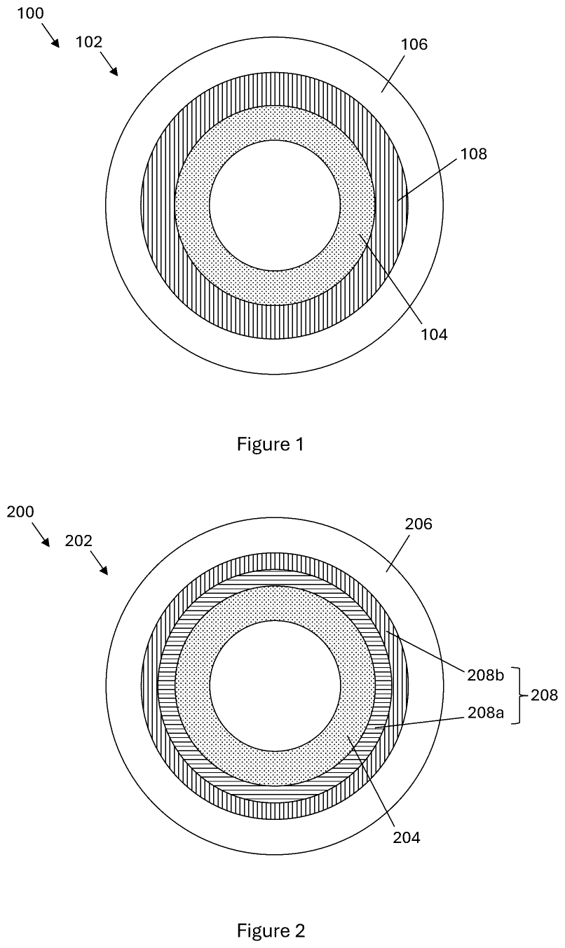

FIG. 1 shows a flexible pipe 100 for conveying oil and gas field fluids according to an embodiment of the invention. The pipe 100 comprises a pipe body 102 comprising first, second, and third pipe layers 104, 106, 108. As shown in FIG. 1, the first pipe layer 104 is an innermost pipe layer and the second pipe layer 106 is an outermost pipe layer. The first pipe layer 104 is a composite layer formed of a reinforcement embedded in a thermoplastic matrix material. However, in certain embodiments, at least one of the first and second pipe layers 104, 106 is a composite layer formed of a reinforcement embedded in a thermoplastic matrix material. The reinforcement improves the creep resistance, and/or stiffness, of at least one of the first and second pipe layers 104, 106. The thermoplastic matrix material provides protection to the reinforcement, i.e., the embedment of the reinforcement in the thermoplastic matrix material shields the reinforcement from environmental factors, chemical exposure, and/or physical damage. Crucially, a heat distortion temperature of the composite layer is greater than 200° F. (˜93° C.) as tested in accordance with ASTM D648 or ISO 75 using an outer fibre stress of 0.455 MPa (˜65.992 psi).

The reinforcement may comprise at least 0.05 wt % and/or up to 60 wt % of the weight of the composite layer. For example, the reinforcement may comprise 20 wt % of the weight of the composite layer. The weight percentage of the reinforcement of the composite layer may be specified, during manufacture of the flexible pipe 100, such that the heat distortion temperature of the composite layer is greater than 200° F. (˜93° C.) as tested in accordance with ASTM D648 or ISO 75 using an outer fibre stress of 0.455 MPa (˜65.992 psi). Testing in accordance with ASTM D648 requires that the test specimen (e.g., the composite layer) is loaded in three-point bending in the edgewise direction. The temperature is increased at 2° C./min until the specimen deflects 0.25 mm. The test procedure of ISO 75 is similar to the test procedure defined in ASTM D648. The reinforcement may comprise any suitable material. For example, the reinforcement may comprise at least one of a plurality of fibres, a plurality of polygonal particles, and a two-dimensional material.

In certain embodiments, the reinforcement may comprise a plurality of fibres. The plurality of fibres may comprise long fibres. The long fibres may have a length over 1 mm and/or up to 100 mm. For example, the long fibres may have a length of 25 mm. Additionally, or alternatively, the plurality of fibres may comprise short fibres. The short fibres may have a length of at least 0.1 mm and/or up to 1 mm. For example, the short fibres may have a length of 0.7 mm. The plurality of fibres may be non-metallic. The plurality of fibres may comprise any suitable non-metallic fibres. For example, the plurality of fibres may comprise one of aramid fibres, glass fibres, basalt fibres, and carbon fibres. In certain embodiments, the plurality of fibres may comprise a combination or one or more of aramid fibres, glass fibres, basalt fibres, and carbon fibres.

In certain embodiments, the reinforcement may comprise a plurality of polygonal particles. The plurality of polygonal particles may be nanoparticles and/or microparticles. The plurality of polygonal particles may be non-metallic. The plurality of polygonal particles may comprise any suitable non-metallic polygonal particles. For example, the plurality of polygonal particles may comprise one of aramid particles, glass particles, nano clays, metal oxides, carbonates or similar, and carbon particles.

In certain embodiments, the reinforcement may comprise planar reinforcement, such as a two-dimensional material. The two-dimensional material may be non-metallic. For example, the two-dimensional material may comprise graphene.

The thermoplastic matrix material may comprise any suitable material. For example, the thermoplastic matrix material may comprise one of a polyvinylidene fluoride, a polyethylene, a polyphenylene sulphide, a polypropylene, a thermoplastic elastomer, and a polyamide. The thermoplastic matrix material may be a monolithic material. The reinforcement may be disbursed homogenously in the thermoplastic matrix material. In this way, the reinforcement may be disbursed throughout the thermoplastic matrix material such that the reinforcement is distributed in a substantially uniform concentration/proportion along a length, depth and/or circumference of the composite layer. Alternatively, the reinforcement may be disbursed non-homogeneously in the thermoplastic matrix material.

The third pipe layer 108 may comprise a further reinforcement embedded in a further thermoplastic matrix material. The further reinforcement provides the flexible pipe 100 with mechanical strength to withstand internal pressures, and other forces, experienced by the flexible pipe 100 in service. The third pipe layer 108 may comprise one or more helically wrapped tapes comprising the further reinforcement embedded in the further thermoplastic matrix material. The helically wrapped tapes may be wrapped having a lay angle of at least 45° and/or up to 90°. In certain embodiments, the third pipe layer 108 may comprise one or more helically wrapped tapes comprising a plurality of metallic wires embedded in the further thermoplastic matrix material. The plurality of metallic wires may comprise steel, a metal alloy, or any other suitable metallic material. In certain embodiments, the plurality of metallic wires may be coated to assist corrosion resistance and/or bonding to the further thermoplastic matrix material. In certain embodiments, the third pipe layer 108 may comprise one or more helically wrapped tapes comprising a plurality of non-metallic unidirectional long fibre tows embedded in the further thermoplastic matrix material. The plurality of non-metallic unidirectional long fibre tows may comprise at least one of aramid fibres, glass fibres, basalt fibres, and carbon fibres.

As shown in FIG. 1, the third pipe layer 108 is disposed intermediate the first and second pipe layers 104, 106. The third pipe layer 108 is disposed about the first pipe layer 104. The third pipe layer 108 may be disposed about a radially outer surface of the first pipe layer 104 such that there is substantially no gap therebetween. The second pipe layer 106 is disposed about the third pipe layer 108. The second pipe layer 106 may be disposed about a radially outer surface of the third pipe layer 108 such that there is substantially no gap therebetween. The first pipe layer 104, the second pipe layer 106, and the third pipe layer 108 may extend coaxially with one another.

In certain embodiments, the pipe body 102 may not comprise the third pipe layer 108 and thereby the second pipe layer 106 may be disposed about the first pipe layer 104. The second pipe layer 106 may be disposed about a radially outer surface of the first pipe layer 104 such that there is substantially no gap therebetween. The first pipe layer 104 and the second pipe layer 106 may extend coaxially with one another.

The first pipe layer 104 may provide an inner liner and/or the second pipe layer 106 may provide an outer cover. The third pipe layer 108 may comprise one of a reinforcement layer (e.g., a pressure armour reinforcement layer), a diffusion barrier, and an insulation layer. In certain embodiments, the first pipe layer 104 and/or the second pipe layer 106 may not comprise a reinforcement layer. The first pipe layer 104 may have a radial thickness of at least 0.25 inches (˜6.35 mm) and/or up to 0.825 inches (˜20.955 mm). The second pipe layer 106 may have a radial thickness of at least 0.125 inches (˜3.175 mm) and/or up to 0.375 inches (˜9.525 mm). The third pipe layer 108 may have a radial thickness of at least 0.125 inches (˜3.175 mm) and/or up to 0.825 inches (˜20.955 mm).

Turning to FIG. 2, there is illustrated a further flexible pipe 200 for conveying oil and gas field fluids according to a further embodiment of the invention. The same reference numerals, offset by a factor of 100, are used to identify the same or similar features as described above.

As shown in FIG. 2, the plurality of the helically wrapped tapes form two distinct sub-layers 208a, 208b within the third pipe layer 208. In certain embodiments, the plurality of the helically wrapped tapes may form more than two distinct sub-layers within the third pipe layer 208. The two distinct sub-layers 208a, 208b comprise a first sub-layer 208a and a second sub-layer 208b. The second sub-layer 208b is disposed about the first sub-layer 208a. The second sub-layer 208b may be disposed about a radially outer surface of the first sub-layer 208a such that there is substantially no gap therebetween. The sub-layers 208a, 208b may be wound with opposing helical orientations. For example, the first sub-layer 208a may be wound in a clockwise direction, and the second sub-layer 208b may be would in a counterclockwise direction. The helically wrapped tapes of each sub-layer 208a, 208b may be applied with at least a partial overlap. For example, the helically wrapped tapes may be wrapped having an overlap between adjacent tapes of at least 0% and/or up to 80%.

The pipe body 102, 202 may be manufactured by an extrusion process. In certain embodiments, the first pipe layer 104, 204 may be extruded using any suitable extrusion technique, in which a thermoplastic resin is melted and pushed through a die that shapes it. Subsequently, the second pipe layer 106, 206 may be extruded to encapsulate the first pipe layer 104, 204 and/or the third pipe layer 108, 208. In certain embodiments, the third pipe layer 108, 208 may be applied in a helical winding pattern about the first pipe layer 104, 204 before the second pipe layer 106, 206 is extruded. The pipe body 102, 202 may be spooled, or fed, onto a spool, or reel, before the thermoplastic matrix material in the first pipe layer 104, 204 and/or the second pipe layer 106, 206 has cooled to ambient temperature.

The invention is not restricted to the details of any foregoing embodiments. In certain embodiments, the first pipe layer 104, 204 may not be a composite layer formed of a reinforcement embedded in a thermoplastic matrix material. For example, the first pipe layer 104, 204 may be formed of a thermoplastic which does not comprise a reinforcement. The second pipe layer 106, 206 may be a composite layer formed of a reinforcement embedded in a thermoplastic matrix material. The second pipe layer 106, 206 may have the properties of the first pipe layer 104, 204, as described above, and visa versa. Throughout the description and claims of this specification, the words “comprise”, “contain”, “having” and variations of them mean “including but not limited to”, and they are not intended to (and do not) exclude other moieties, additives, components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, or characteristics described in conjunction with a particular aspect, embodiment or example of the invention are to be understood to be applicable to any other aspect, embodiment or example described herein unless incompatible therewith. In particular, the words “certain embodiments” are to be understood to mean any embodiment described, illustrated, or otherwise disclosed herein, unless expressly stated otherwise. All of the features disclosed in this specification (including any accompanying claims, abstract and drawings), and/or all of the steps of any method or process so disclosed, may be combined in any combination, except combinations where at least some of such features and/or steps are mutually exclusive. The invention extends to any novel one, or any novel combination, of the features disclosed in this specification (including any accompanying claims, abstract and drawings), or to any novel one, or any novel combination, of the steps of any method or process so disclosed.

1. A flexible pipe for conveying oil and gas field fluids, the pipe comprising a pipe body comprising first and second pipe layers, the first pipe layer being an innermost pipe layer and the second pipe layer being an outermost pipe layer,
wherein at least one of the first and second pipe layers is a composite layer formed of a reinforcement embedded in a thermoplastic matrix material, and
wherein a heat distortion temperature of the composite layer is greater than 200° F. as tested in accordance with ASTM D648 or ISO 75 using an outer fibre stress of 0.455 MPa.

2. A flexible pipe according to claim 1, wherein the reinforcement comprises at least one of a plurality of fibres, a plurality of polygonal particles, and a two-dimensional material.

3. A flexible pipe according to claim 2, wherein the plurality of fibres comprises one of aramid fibres, glass fibres, basalt fibres, and carbon fibres.

4. A flexible pipe according to claim 1, wherein the thermoplastic matrix material comprises one of a polyvinylidene fluoride, a polyethylene, a polyphenylene sulphide, a polypropylene, a thermoplastic elastomer, and a polyamide.

5. A flexible pipe according to claim 1, wherein the first pipe layer provides an inner liner and/or the second pipe layer provides an outer cover.

6. A flexible pipe according to claim 1, wherein the pipe body comprises a third pipe layer disposed intermediate the first and second pipe layers.

7. A flexible pipe according to claim 6, wherein the third pipe layer comprises one of a pressure armour reinforcement layer, a diffusion barrier, and an insulation layer.

8. A flexible pipe according to claim 6, wherein the third pipe layer comprises one or more helically wrapped tapes comprising a plurality of metallic wires embedded in a thermoplastic matrix material.

9. A flexible pipe according to claim 6, wherein the third pipe layer comprises one or more helically wrapped tapes comprising a plurality of non-metallic unidirectional long fibre tows embedded in a thermoplastic matrix material.

10. A flexible pipe according to claim 8, wherein a plurality of the helically wrapped tapes form at least two distinct sub-layers within the third pipe layer, the sub-layers being wound with opposing helical orientations.

11. A flexible pipe according to claim 10, wherein the helically wrapped tapes of each sub-layer are applied with at least a partial overlap.

12. A method of manufacturing a flexible pipe for conveying oil and gas field fluids, the method comprising:
forming a flexible pipe according to claim 1, wherein the forming includes extruding the composite layer such that the thermoplastic matrix material is at an elevated temperature relative to ambient temperature; and
feeding the flexible pipe onto a reel before the thermoplastic matrix material has cooled to ambient temperature.
